(19) United States
(12) Patent Application Publication
(10) Pub. No.: US 2018/0248896 A1
(43) Pub. Date: Aug. 30, 2018

(54) SYSTEM AND METHOD TO PREVENT, DETECT, THWART, AND RECOVER AUTOMATICALLY FROM RANSOMWARE CYBER ATTACKS, USING BEHAVIORAL ANALYSIS AND MACHINE LEARNING

(71) Applicant: ZitoVault Software, Inc., Carlsbad, CA (US)

(72) Inventors: Antonio Challita, Carlsbad, CA (US); Emmanuel Tsukerman, Oceanside, CA (US); Hugh O'Brien, San Diego, CA (US); Tim McElwee, Escondido, CA (US)

(21) Appl. No.: 15/669,761

(22) Filed: Aug. 4, 2017

Related U.S. Application Data
(60) Provisional application No. 62/463,526, filed on Feb. 24, 2017.

(51) Int. Cl. H04L 29/06; G06F 21/62; G06F 11/14

(52) U.S. Cl. CPC H04L 63/1416; G06F 21/6218; H04L 63/168; G06F 2201/84; G06F 11/1451; G06F 2221/2107; G06F 2201/80; H04L 63/061

(57) ABSTRACT

An anti-ransomware system for a computer system has a deception component comprising a decoy module configured to place decoy segments within one or more file systems, a detection component comprising a behavioral analysis module configured to analyze the behavior of a suspected ransomware, and a response component. The response component has a suspend/kill module configured to suspend the suspected ransomware, a restore files module configured to restore files from an on-demand backup system, a capture encryption key module configured to retrieve the encryption used by the suspected ransomware, and a quarantine module configured to quarantine the suspected ransomware on the device and to quarantine the device off the network, to prevent spread of infection. In an embodiment, the detection and/or response components operate within a kernel-level access. The system's detection component may further comprise a machine-learning module, and the decoy segments may be on-demand and dynamic.

### CROSS-REFERENCE TO RELATED APPLICATION(S)

The present application claims priority to U.S. Provisional Patent Application No. 62,463526 filed on Feb. 24, 2017, entitled “System and method to detect rapidly, thwart automatically, and recover seamlessly from Ransomware cyber attacks” the entire disclosure of which is incorporated by reference herein.

### BACKGROUND OF THE INVENTION

1. Field of Invention

The present invention relates to the field of cyberattacks and in particular to the field of preventing, detecting, responding to and recovering from, ransomware attacks.

2. Description of Related Art

Ransomware is a cybersecurity attack utilized by cybercriminals to digitally encrypt data on their victim's devices typically using strong encryption, and demand a ransom payment (typically in Bitcoin) to return the files to their original state. Ransomware continues to be one of the fastest growing and most dangerous cybersecurity attacks in the industry, as well as most lucrative for criminals. Studies have shown that ransomware families have grown by an astonishing 750% year-over-year in 2016. In 2017, a ransomware attack known as WannaCry become of the biggest cybersecurity attacks ever to hit globally. It shut down hospitals, impacted telecommunications companies, and spread to over 150 countries and approximately 300,000 devices.

Ransomware is targeting virtually all business industry verticals, including enterprises, small and medium businesses, government agencies, public libraries, transportation systems, universities, and hospitals. Ransomware also targets end consumers directly. Typically, Ransomware demands in end consumer scenarios consist of lower amounts of payments than when businesses are targeted.

Another dangerous trend that is evolving in the industry is the increase in popularity of Ransomware-as-a-Service (RaaS). RaaS is a business model used by hackers to recruit other bad actors to distribute ransomsware more broadly, and share the profits from the ransom payments. Typically, ransomware authors keep 30% of the ransom payment, and distributors retain 70%. In some instances, Ransomware is also being combined with threats to leak data (business or personal) publicly online, if ransom payments are not made. This is also referred to as leakware.

The growth of Ransomware attacks is driven primarily by the following reasons. Firstly, Cybercriminals are motivated by the direct financial gains that ransomware attacks provide. At the time of writing, the average ransom amount per device is over $650. That value often exceeds $1,000 per device when the victim is a business entity, as opposed to end consumer. This is because businesses are tvpically more pressured than end consumers, to restore their data rapidly, to restore their business continuity. It's worth noting that the biggest impact on businesses from ransomware attacks, often comes from service disruption, which often dramatically exceeds the ransom amount. Secondly, the rise in popularity of cryptographic currency (such as Bitcoin) has facilitated the ability of criminals to collect payments from their victims anonymously in a manner that is a lot more difficult to track by authorities. At the time of writing, Bitcoin is the predominant payment method demanded by Ransomware attackers. Thirdly, the emergence of the lucrative Ransomware-as-a-Service (RaaS) phenomena is making it easier for virtually anyone, even people with no hacking or technical experience, to obtain and distribute ransomware attacks in a short amount of time. Fourthly, existing security solutions, to a large extent, continue to fail against protecting devices from social engineering attacks on people. Hackers are, able, to carefully craft phishing emails that trick people into clicking on malicious links, which triggers the start of their Ransomware attack.

Business and consumers can take the following approach to mitigate Ransom ware attacks: 1) backing-up personal and business-related data frequently, wherein the back-up storage devices should be disconnected from the network before and after the back-up operation is performed as some ransomware strains intentionally scan for storage devices connected to the network, and encrypt the data on them; 2) awareness and education, which may comprise programs used by businesses designed to train people on risky security scenarios, such as avoiding clicking on malicious links in phishing emails and spear-phishing campaigns; avoiding opening suspicious email attachments; avoid clicking malicious advertisements on websites; avoid plugging in potentially infected USB s found in untrusted locations (such as parking lots); 3) firewalls that can help block known suspicious IP addresses and domains from communicating with devices in your network, that could host ransom ware command & control servers; and 4) installing anti-virus software and keeping it up to date. This can help protect devices from ransomwares strains, with known signature hash values, from successfully executing on the device and encrypting files.

A modern behavioral-based solution may provide advantages that prior art solutions do not. For example, existing solutions to combat ransomware face the following challenges. Firstly, back-up devices are being targeted by ransomware attacks, essentially rendering the back-up data unusable. Secondly, there is a lack of education and awareness. Statistics continue to show that people remain the weakest link in cybersecurity attacks, including ransom ware attacks. A significant percentage of ransomware attacks (over 50%) start through phishing emails. Thirdly, firewalls lack detailed visibility of the software executing on endpoint devices (such as PCs and Laptops), to be able to determine whether certain software is malicious. Additionally, attackers create and change domains names that host suspicious command and control servers at a rapid pace. This makes it difficult for the blacklisted databases used by firewall vendors to discern harmful domains and keep up with attackers. Fourthly, anti-virus solutions typically use signature-based approaches, which rely on large databases of known bad signatures to identify malicious files. The primary drawback of this approach is that it requires a first victim to be infected in order to determine that a certain file is malicious. After the first infection, it takes some time for the malicious signature to be updated into the database of malicious signatures, and propagate to all users. During that time, the ransomware and new variants may go undetected.

Some ransomware variants have automated an ability to change their signature (polymorphic variants) periodically or on triggering events. With a 15-second variations time, it is almost impossible for a signature-based anti-virus to detect and stop them.

Modern behavior-based solutions in the art exhibit drawbacks as well, however, as some of the competitive solutions were slow to respond to ransomware attacks when tested by independent 3rd parties, and alerted the user only after the damage has been done. They may consume high memory and CPU resources on the system that could impact normal machine usage, particularly when solutions are combined with legacy endpoint security solutions. Furthermore, some of the solutions automatically terminate legitimate processes, after falsely classifying them as ransomware, resulting in disruption of normal machine usage. Frequently prior art behavior-based solutions generally lacked the ability to run on different types of operating systems.

Based on the foregoing, there is a need in the art for a ransomware detection and mitigation solution that uses a behavior-based, signature-less approach to effectively detecting, stopping and recovering from ransomware attacks in real time.

### SUMMARY OF THE INVENTION

An anti-ransomware system for a computer system has a deception component comprising a decoy module configured to place decoy segments within one or more file systems, a detection component comprising a behavioral analysis module configured to analyze the behavior of a suspected ransomware, and a response component. The response component has a suspend/kill module configured to suspend the suspected ransomware, a restore files module configured to restore files from an on-demand backup system, a capture encryption key module configured to retrieve the encryption used by the suspected ransomware, and a quarantine module configured to quarantine the suspected ransomware on the device, and to quarantine the device off the network, to prevent spread of infection.

In an embodiment, the behavioral analysis module determines spread of the suspected ransomware and triggers the response component when a predetermined threshold of spread is passed. In another embodiment, the detection and/or response components operate within a kernel-level access.

The system's detection component may further comprise a machine-learning module, and the decoy segments may be on-demand and dynamic.

In an embodiment, an anti-ransomware method is disclosed and has the steps of operating a deception component, wherein a decoy module of the deception component places and monitors decoy segments within one or more file structures, operating a detection component wherein a machine learning module of the detection component determines a file system baseline for the computer file structure, and a behavioral analysis module analyzes a suspected ransomware, and operating a response component which responds to a suspected ransomware by an action selected from the group consisting of suspending the suspected ransomware process, restoring files from a backup, capturing an encryption key, and quarantining the suspected ransomware.

The detection component may have the further steps of engaging in static analysis the suspected ransomware, that prevent the ransomware from launching prior to its execution, wherein if the suspected ransomware is suspicious the detection component is moved to a suspicious state, and wherein if the suspected ransomware is malicious the detection component is moved to a malicious state and wherein if the suspected ransomware is safe, the detection component is moved into a safe state, engaging in early dynamic analysis of the suspected ransomware wherein if the suspected ransomware is suspicious the detection component is moved to a suspicious state, and wherein if the suspected ransomware is malicious the detection component is moved to a malicious state. If the suspected ransomware is safe, the detection component is moved into a safe state, engaging in ongoing dynamic analysis of the suspected ransomware wherein if the suspected ransomware is suspicious the detection component is moved to a suspicious state, and wherein if the suspected ransomware is malicious the detection component is moved to a malicious state and wherein if the suspected ransomware is safe, the detection component is moved into a safe state. If the detection component ends in a safe state, a flag is not raised, and data is sent to a cloud computer wherein if the detection component ends in a suspicious state, a flag marked suspicious is raised, and data is sent to a cloud computer, and wherein if the detection component ends in a malicious state, a flag marked malicious is raised, and data is sent to a cloud computer.

In an embodiment, the response component comprises the steps of receiving a flag marked suspicious or malicious from the detection component, analyzing the suspected ransomware, whereas if ransomware is confirmed, suspending a ransomware process, restoring backed up files, undoing malicious modifications made by the ransomware, and quarantining the ransomware off-network.

The method may have the additional the step(s) of the user confirming that the process is malicious, and/or the step of an artificial intelligence system confirming that the process is malicious. In an embodiment, the step of a security analyst reviewing the data associated with the security event, and confirming that the process is malicious, is performed.

The step of an automated response confirming that the process malicious may also be used, as well as the step of deleting the ransomware file. In an embodiment, the method also has the step of backing up one or more files that are targets for encryption.

The backing up process is performed on-demand. The step of capturing the encryption key from memory and decrypting files that have been encrypted by the ransomware, may also be performed.

Additional method steps include the step of sending the encryption key to a cloud computer, and the system using the decoy segments placed within the folder of the suspected ransomware.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a functional view of the system architecture, according to an embodiment of the present invention;

FIG. 2 is a diagrammatic view of the communication of the system with the cloud, according to an embodiment of the present invention;

FIG. 3 is a visual depiction of the concept of spread, according to an embodiment of the present invention;

FIG. 4 is a machine layer view of the operation of the system, according to an embodiment of the present invention;

FIG. 5 is a flowchart view of the detection component, according to an embodiment of the present invention; and

FIG. 6 is a flowchart view of the response component, according to an embodiment of the present invention.

### DETAILED DESCRIPTION OF PREFERRED EMBODIMENTS

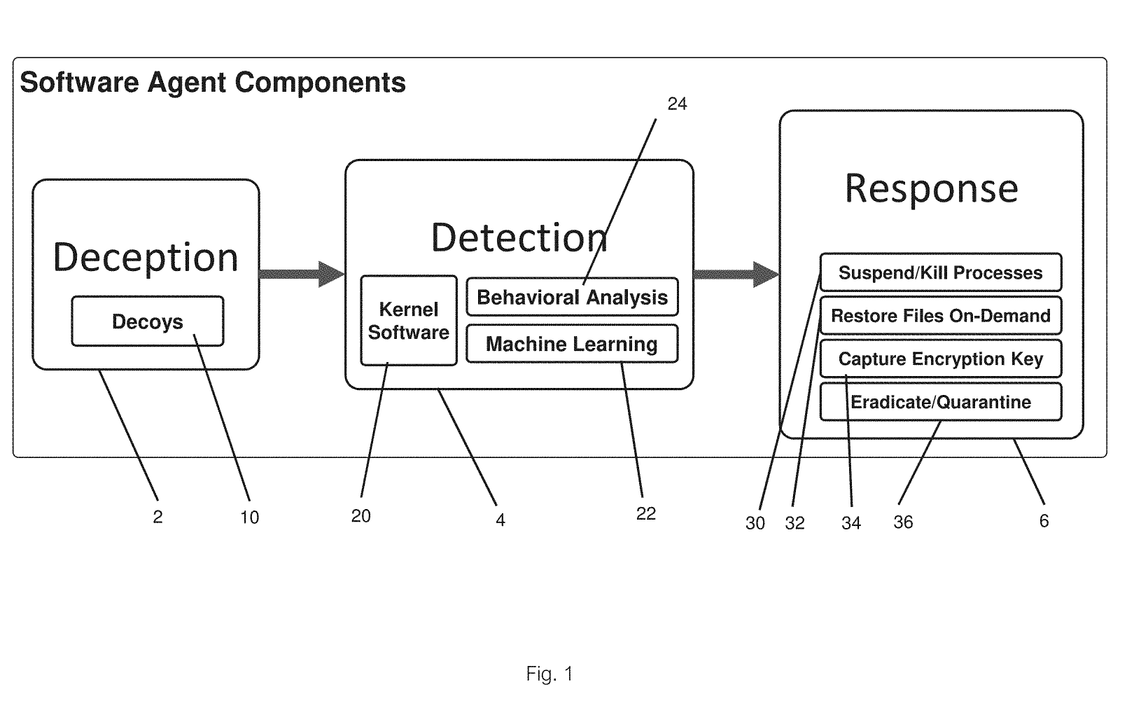

Preferred embodiments of the present invention and their advantages may be understood by referring to FIGS. 1-6, wherein like reference numerals refer to like elements.

In the below, “computer” is defined as any electronic, computational device including personal computers like laptops, one or more servers interconnected within the cloud, and smartphones and other personal devices, as well as IoT (Internet of Things) devices, individually or multiple, networked units. “File system” may be defined as a typical file system for an individual computer, but also networked file systems or portions of file systems, and any data storage, residing on one or more computers, as defined above.

With reference to FIG. 1, the software agent comprises three major components, a deception component 2, a detection component 4, and a response component 6. The deception component contains a decoy component 10, which comprises files and/or folders that are placed strategically throughout the computer storage, and which may be periodically updated to update a time stamp or show recent activity. As soon as certain actions are taken on the decoys, such as encryption, detection, writing or editing, the detection component is notified. The goal of decoys is to detect ransomware encryption operations, and slow down the ransomware from achieving its objectives.

Decoy files and folders can contain common file types that Ransomware attackers target. Those include PDF, .doc, .docx, .ppt, .xls, .xlsx, .jpeg, .png. To make the folders more attractive, decoy information can be generated using common strings such as “username”, “password”, “bank account”, “login”, “credit card number”, “social security number”, that may represent personal information, and therefore files of greater value to the computer user. In order to emulate these valuable data, random or predetermined numbers matching credit card format and social security format are placed in those files. Similarly, decoys may comprise copies or variations of photos or videos of family members, representing irreplaceable memories, such that they attract the action of the ransomware first. The decoys may be decoy segments, wherein the decoy portion is piggybacked onto an existing file, or the decoy exists as a standalone file, or the decoy comprises a plurality of files. The decoys may also be on-demand and dynamic, being created and placed as suspected ransomware is detected.

The purposes of the decoys, without limitation, may comprise i) alerting about ransomware-like behavior, ii) alerting about “snooping” on the computer, iii) potentially storing anti-malware components disguised as decoys, iv) slowing down the encryption process, yielding additional response time, v) deterring attackers, vi) allowing additional opportunities to recover the key, or learn how to recover files.

The second major component is the detection component 4, comprising kernel software 20, which operates at a kernel level and monitors ransomware activities in real time. Since it's located in the kernel-mode driver layer of the operating system, the software runs with higher privileges and can act, and react, faster that user-mode applications and processes on the system.

The kernel software 20 provides the ability to i) monitor and analyze all User-Mode applications and processes running, ii) monitor all operations on the file system on the machine, including read/write operations on the files, iii) having permissions and rights to respond to suspicious actions of any running process or application, and iv) perform all of the above at a fast pace (much faster than user-mode) to detect and contain suspicious attacks, before they encrypt files.

The detection component also has a machine learning component 22 and a behavioral analysis component 24. The machine-learning component determines a baseline of machine behavior, for that particular machine, to be established.

As a pattern of massive change of individual files is potentially indicative of ransomware, as these actions are similar to actions habitually taken by ransomware once it starts operating, if files are changed massively (beyond a predetermined threshold) within a short time, the machine-learning component 22 is consulted. The component 22 determines a baseline for different files in different location, as to normal usage, to provide a baseline for benign, normal user activity. The system must learn to identify them to avoid taking action when these benign activities are undertaken. Through machine learning, the system determines normal use thresholds for file changes and stores these thresholds for future reference. The machine learning observes the normal processes of the machine, including behavior that results in large changes at one time to particular files, such as compressing or encrypting files within normal use of the computer, that weren't previously encrypted or representing user content. In an embodiment, once a file change activity exceeds a threshold, the system stops monitoring and takes action by notifying the response component 6.

Clustering techniques allow the detection of large numbers of file changes in a short amount of time, in real time. Clustering algorithms that may be used, without limitation, include hierarchical clustering and centroid-based clustering. Along with the use of decoy files or data, clustering forms an additional line of defense that flags a process that is performing file changes quickly, early in its operation, in one embodiment determined by the timestamp of the event. In addition, certain operations occurring during the beginning stages of ransomware execution are monitored and used for detection. For example, registry key changes and system calls occurring during the 1st second of execution of a new program are closely monitored.

Monitoring for clustering detects rapid file manipulation or conversion activity of a process. Rapid file activity generally means many file changes occur in a short duration of time. The threshold is determined by the machine learning observing normal usage for a period of time (1 day or 1 week) based on the fact of ransomware being unlikely to strike within that early learning period. The learning period may be based on the specification of the computer, rather than a learning period. Clustering monitoring works using two parameters: inter-cluster distance and critical cluster size. The time stamps of file changes made by a process are recorded and compared; if they are close together in time (less than inter-cluster distance), then they may be designated as part of the same cluster. If a cluster reaches the critical cluster size, determined by the pre-determined criteria resulting in optimal parameters, the process is designated as effecting rapid activity. The two parameters are determined by the machine-learning component to reduce the number of false positives.

To reduce false positives, however, secondary features are used. Such features include: i) measuring an increase of entropy of files, ii) observing changes in file extensions (magic numbers), and iii) observing dissimilarity of files before and after using a similarity-hash, such as sdhash or other implementations of similarity hashing known in the art.

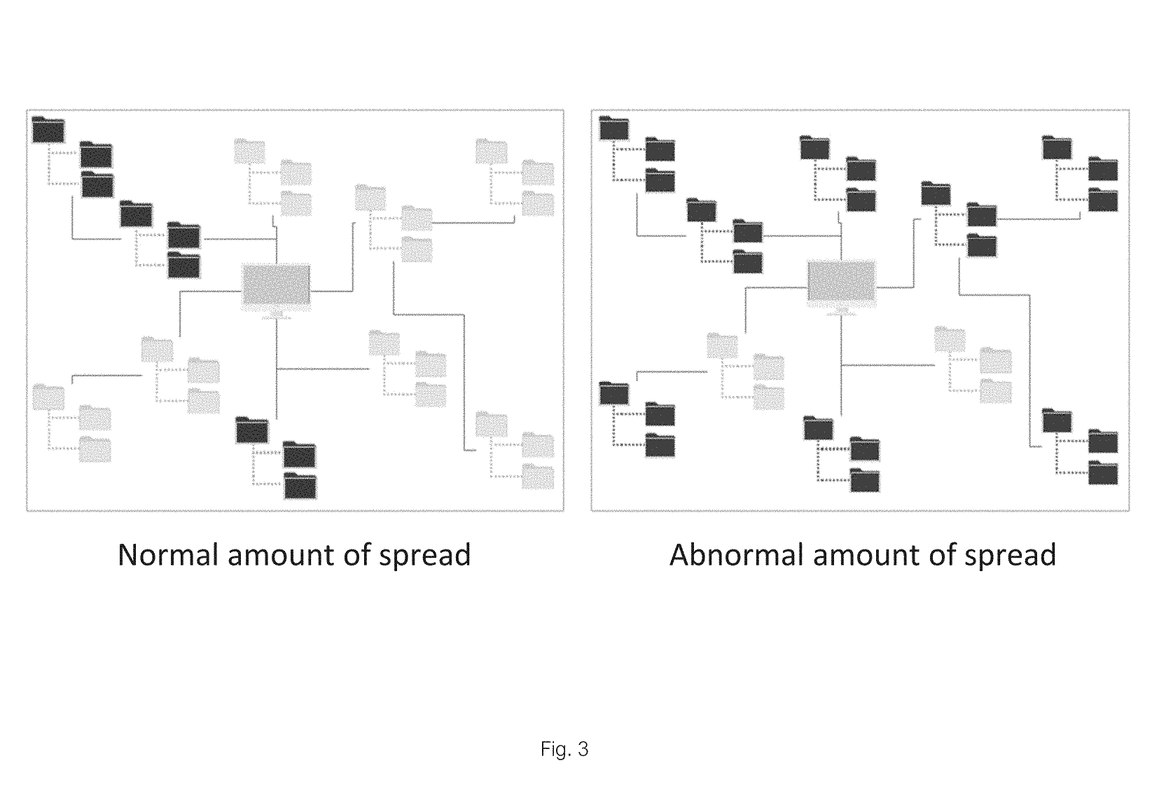

With reference to FIG. 3, another feature monitored is “spread” during execution and enumeration. Spread measures the degree to which a process is visiting or enumerating a large number of seemingly unrelated directories. According to typical behavior, ransomware is likely to score highly on this feature as its aim is to visit every part of the user's system. On the other hand, an installation program is likely to have low spread, because the file changes it makes are localized to a small number of related directories.

Spread represents the extent to which a process is making activity in a wide array of unrelated folders. In other words, whether it has been spreading throughout the system, or has been localized to few folders. The greater the activity is dispersed throughout the system, the greater the spread. This feature may help prevent ransomware before encryption even begins by detecting their file and folder enumeration. This is not always done in every embodiment, however determining spread carries little risk of false positives and is therefor a preferred indicator. The simplest implementation of the feature considers the list of file paths of changed files made by the process.

The system then truncates their names to a depth of D (e.g., D=3). Then it counts the number of such distinct truncated file paths. If this number exceeds a critical number C (e.g., C=10), then the process is said to have large spread and the response component 6 is notified.

The response component 6 comprises a suspend/kill process module 30, a restore module 32 to restore files on demand, a capture encryption key module 34, and an eradicate/quarantine module 36.

The suspend/kill process module 30 suspends (pauses) or kills (terminates) a suspicious process associated with a Ransomware attack once it is identified, to prevent the malicious the process from executing further. In an embodiment, the default behavior is to “suspend” before “terminating”. A notification may be sent to the user, and if the user confirms that it's a malicious process, the application will terminate it. Notification is also provided to the administrator, and if the administrator confirms that it's a malicious process, the application will terminate it. If further analysis confirms with high certainty that it's a malicious process, it will automatically be terminated by the application. A confirmation may come from the cloud, or as a result of further analysis performed locally on the endpoint. This is done to prevent the malicious process from encrypting additional files. Directly after the process suspension is performed, the solution provides a notification to the user, informing them that malicious behavior has been detected on the machine. The system may automatically terminate the process and delete the ransomware or the notification prompts the user to instruct the system to ALLOW the file action (make an exception to the ransomware detection) or BLOCK it. ALLOW permits the process to run and adds the process to a whitelist of acceptable processes, whereas BLOCK prevents the process from running further, and causes the process to be placed on a blacklist. The user may instruct the system to perform a responsive action such as locking up certain files, and preventing modification by any application or process, until the user makes the decision of ALLOW or BLOCK.

The restore module 32 provides back-up for files on demand, that in an embodiment commences when a suspicious process is detected, that may be encrypting files illegitimately. A copy of the plain text files is created before the file-write operation of the encryption process is allowed to execute. In an embodiment, the application has higher priority, and will be able to perform the copy operation before the write operation. Once the back-up is made, a determination may be made if the process is legitimate or malicious. If the process is determined to be malicious, it is terminated and the plain text copies of the original files are restored to the user by the solution. If the process is determined to be legitimate, the plain text copies of the files are discarded and the legitimate process is allowed to continue executing. In an embodiment, the plain text files can also be “cached” instead of copied, when a suspicious process is detected. If the process is determined to be legitimate, the plain text copies of the files are discarded, and the legitimate process is allowed to continue executing.

The key capture module 34 operates to capture the encryption key of the Ransomware attack. While the encryption of files is taking place in the ransomware process, the RAM memory of the machine is dumped and analyzed by the key capture module 34, and the [symbol] encryption key used by the Ransomware attack is captured.

The premise behind key capture/interception is that a Ransomware attacker must decide what encryption key is to be used in their attack. Typically, the attacker will maintain a database of corresponding decryption keys in the cloud, for each of the machines they have targeted. The encryption key for the files on the current machine must be exposed in memory, for the encryption operation to be able to proceed. Alternatively, the encryption key will be available as it is passed into the operating system's cryptographic functionality modules (through, for example, Application Programming interfaces, APIs). Capturing keys will work even for ransomware attacks that generate the keys locally, within the machine (also known as offline encryption), without communicating with a command and control (C&C) server to obtain the encryption key. The solution will work for symmetric encryption, which is commonly used in ransomware as the performance symmetric encryption is much faster than asymmetric encryption. Note that ransomware attacks that use an asymmetric encryption key pair, let's call it the master key pair, typically also use symmetric key encryption. In these cases, the master key pair is used to generate a symmetric encryption key, let's call is the session key, that will be used for the actual encryption operation. The method described in this patent application recovers the session key and can decrypt the files, which makes the recovery the master key unnecessary.

Typically, master keys are based on RSA 2048 and session keys are based on AES 256 encryption algorithms

The eradicate/quarantine module 36 may undo or reverse registry changes made by the ransomware (such as updating Auto-Start registries in Windows, or attempting to modify the Windows Volume Shadow Copy Service, VSS). Some Ransomware try to change the registry values, for example to auto-start every time the computer is restarted. The system searches and compares for changes to registries that have been made by suspicious files, and corrects them with reference to a stored copy. The module may also delete the malicious ransomware file from the machine. Alternatively, the solution can change the file extension, to prevent the file from being executable. In an embodiment, the system may quarantine the machine off the network by disabling network connectivity (to both wireless and wired connectivity protocols) so that the ransomware cannot spread to other machines connected by network.

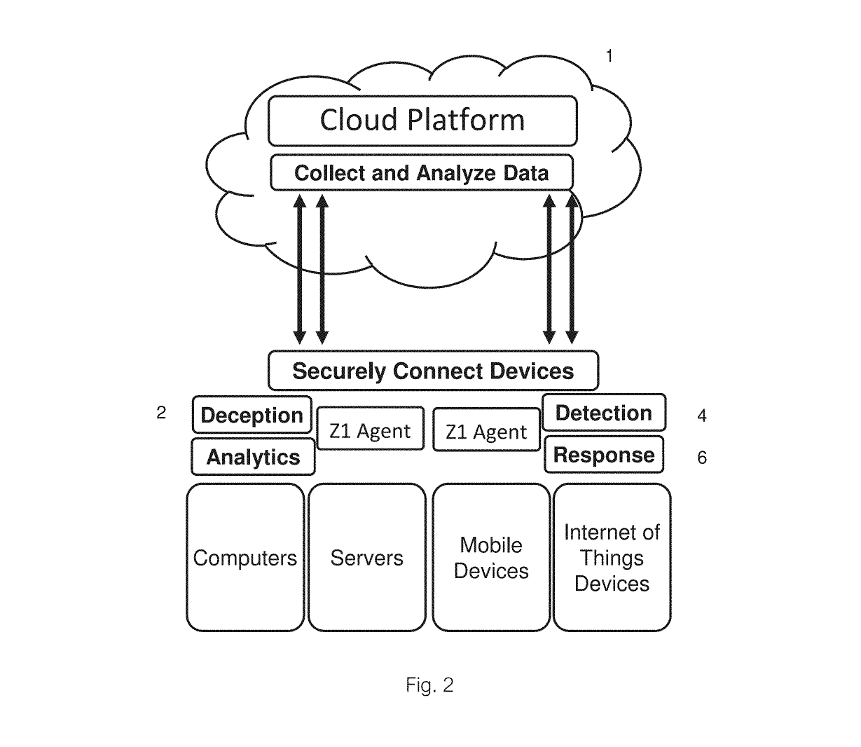

With reference to FIG. 2, in an embodiment, a centralized database for use by the system resides in the cloud 1, while the deception component 2, the detection component 4, and the response component 6 reside on securely connected devices. Data may be periodically transmitted from endpoint devices to a cloud platform, using secure channels, and stored in a centralized database. The data includes suspicious processes names, suspicious file names, and suspicious file hashes. This enables the creation of a threat intelligence platform, on malicious indicators of ransomware attacks, and so the data may be easier to transmit between systems at disparate installation, in order to update behavioral patterns for ransomware recognition. Data on user responses to ALLOW or BLOCK operations are also sent to the cloud, to be remembered for that user installation. Responses to the same queries are aggregated from all users (crowd-source) and a summary is presented to new users to enable them to determine a risk. For example, “a particular process was considered to be malicious by 92% of users—would you like to block it?”

Data on the external destinations (IP addresses or domains) that the endpoint is communicating with, can also be collected, and correlated against known malicious IP addresses or domain names, associated with Ransomware command and control servers. Collecting and correlating data in the cloud, enhances detection rates, and helps enable proactive protection of endpoints, before the Ransomware encryption process can start.

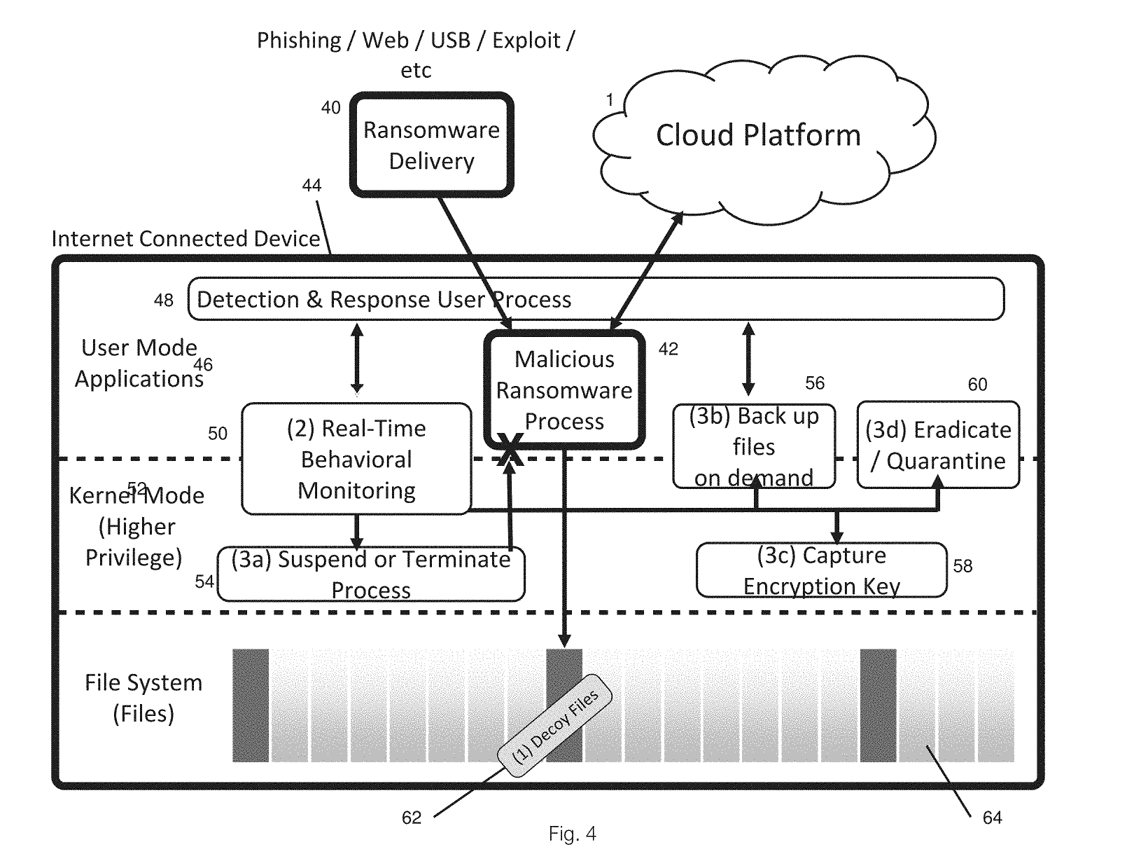

With reference to FIG. 4, the ransomware delivery 40 is provided externally to the device, and may enter the device through numerous channels such as breaking in or phishing. Once it establishes itself within the computer 44, it becomes a malicious ransomware process 42 that communicates with the cloud 1 periodically. In the user mode application layer 46, the detection and response user process 48 is running The detection and response user process 48 communicates with the real-time behavior monitoring 50 which operates partially in kernel mode 52 for higher privileges. The detection and response user process 48 communicates with the back up files module 56 in the kernel 52. The capture encryption key module 58 resides in the kernel 52 and communicates with the ransomware malicious process 42. The suspend/terminate process module 54 resides within the kernel 52 as well. The eradicate/quarantine module 60 resides in both user mode 46 and kernel mode 52 layers. The decoy files 62 are kept within the user file portion 64 of the machine, selectively inserted into the file structure. The real-time behavior monitoring 50 is in communication with all level 3 processes, namely suspend or terminate process 54, back-up files on demand 56, eradicate/quarantine 60, and capture encryption key 58.

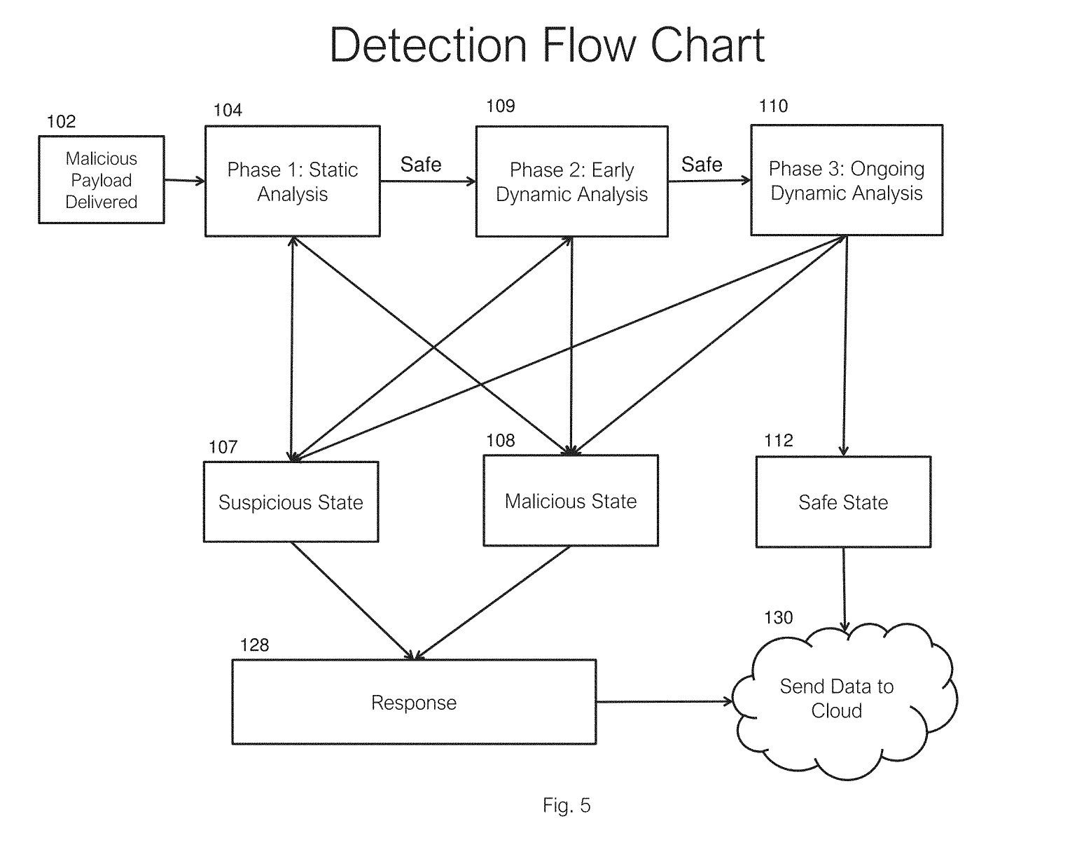

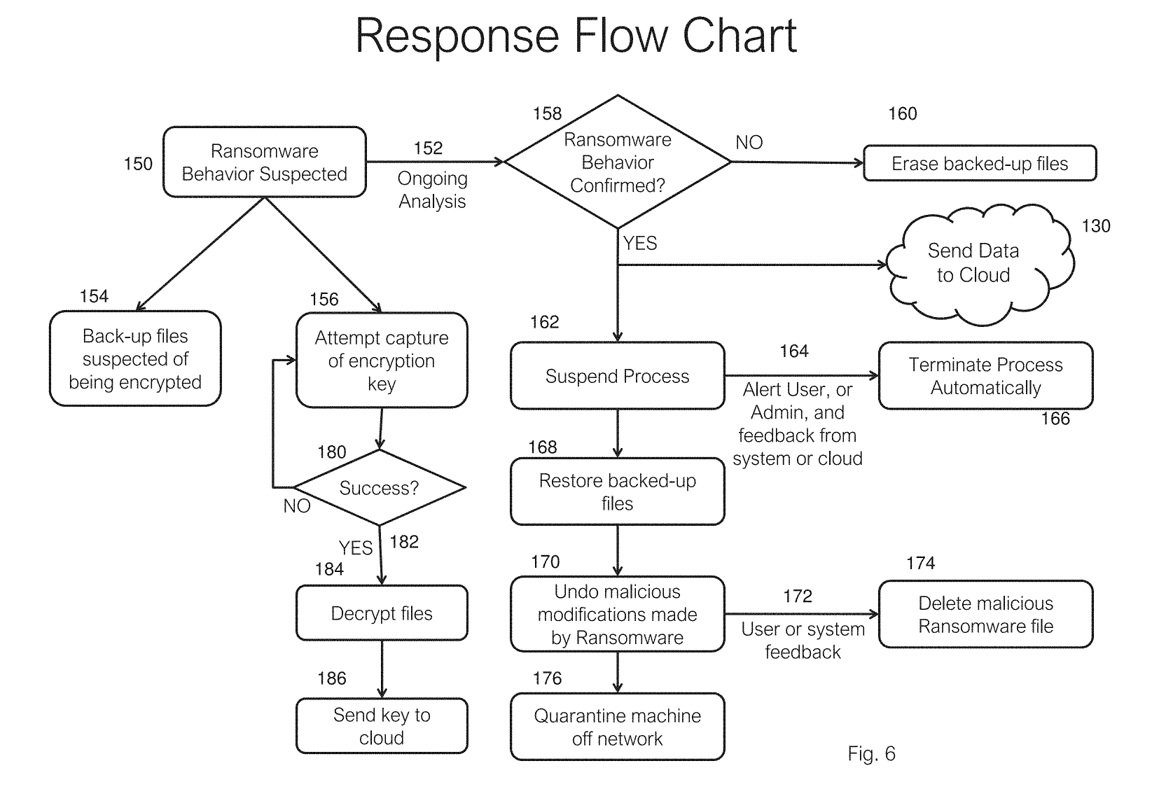

With reference to FIG. 5, a flowchart showing the operation of the detection component, in an embodiment, is shown. In step 102 the malicious payload is delivered. In step 104, the static analysis commences (Phase 1), and processing by machine learning classifiers 106 produces a determination of whether the malware is malicious at step 108 or suspicious at step 107. If the malware is determined not to be malicious (safe), at step 109 the system activates early dynamic analysis (Phase 2). At the same time, at step 110 the process is monitored by ongoing dynamic analysis (Phase 3), which comprises on-going dynamic analysis including decoys, clustering, spread, entropy, similarity hashing and magic number changes. If it has not yet started, the system waits. A determination as to whether the behavior is suspicious (step 107), malicious (step 108), or safe (step 112). If ransomware behavior is detected, the system alerts the user(s), and passes the process over to the response component (see FIG. 6), and also the notification, along with signature information is transmitted to the cloud-based portion of the system at step 130. Similarly, if the malware is determined to be malicious at step 108, the system alerts the user(s) passes the process over to the response component (see FIG. 6), and also the notification, along with signature information is transmitted to the cloud-based portion. If the malware is determined to be safe at step 112, the information is reported to the cloud in step 130.

With reference to FIG. 6, the response component, in an embodiment, is shown in flowchart form. In step 150, ransomware behavior is suspected, and, in an embodiment, three processes commence. Firstly, ongoing analysis commences at step 152. Secondly, the back-up of the system's files begins in step 154, wherein the backup is an on-demand backup that, in an embodiment, prioritizes the backing up of files to those that appear to be the next targets for the encryption. In step 156 the system commences an attempt to capture the encryption key.

Once the ongoing analysis starts at step 152, in step 158 the ransomware behavior is either confirmed or not. If yes, information is transmitted to the cloud at step 130. In an embodiment, the entire process from discovery of the malware, through suspension and remediation, is logged to the cloud at step 130. If not, then backed up files are erased at step 160 and the system returns to a state of ongoing monitoring. If it is confirmed, then the process is suspended at step 162 by the system, and user or system feedback may be requested at step 164. The possible responses at step 164 include i) the user confirming that the process is malicious; ii) an artificial intelligence system confirming that the process is malicious; iii) a security analyst reviewing the data associated with the security event, and confirming that the process is malicious; and iv) an automated response confirming that the process malicious. If the malware is confirmed to be malicious, the process is terminated at step 166 and a report is stored. The back-up files are restored at step 168, once the process is terminated, and in step 170 the system is analyzed for malicious modifications made by the ransomware, and if any are found, these are reversed or undone. In step 172, user or system feedback is requested, and if the file is not identified by the user, or the file contravenes a system rule, the system deletes the ransomware file in step 174. The system may also quarantine the machine off the network in step 176.

Once the process to capture the encryption key launches at step 156, the process continues at step 180 until successful. Once success is achieved at step 182, the files are decrypted using the key at step 184 and the key is sent to the cloud-portion of the system at step 186.

In an embodiment, another aspect of the invention in the deception component 2 has to do with the ability of generating decoys on-demand and in a dynamic manner. In this embodiment, decoy files are automatically created in the same folder location as where a suspicious file executes. If that suspicious file turns out to be ransomware and starts the encryption process in the same location into which it was downloaded, then those decoy files will be among the first to be encrypted and will detect the encryption operation first, at which point the system will be engaged to stop the ransomware. Note that this dynamic decoy feature may have additional applicability outside ransomware detection/deception. For example, it could apply in applications that are being used to back-up files or synchronize files automatically. The decoys may be decoy segments, wherein the decoy portion is piggybacked onto an existing file, or the decoy exists as a standalone file, or the decoy comprises a plurality of files.

In an embodiment, another aspect of the system in the detection component 4 has to do with the application monitoring for scanning operations on the network. This is because certain variants of ransomware strains attempt to scan the local area network, to spread the infection to other machines on the same network. Scanning operations can therefore be used as a further indicator of malicious activity and potentially or ransomware activity.

Another aspect of the system concerns applying Predictive Analytics on the cloud platform. This allows the solution to determine, based on certain parameters, such as user profiles, demographics, age group, occupation, location, and other inputs (all data that is stored and processed in the cloud), whether certain users will have a higher likelihood of being targeted by cybersecurity attacks, or whether certain phishing attacks would more likely target certain user groups with higher success rates. In those scenarios, the application can proactively activate higher security controls on the endpoint agent. Those controls include increasing the false positive thresholds, and increasing the frequency of performing on-demand back-ups.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An anti-ransomware system for a computer system, comprising:
a. a deception component comprising a decoy module configured to place decoy segments within one or more file systems;
b. a detection component comprising a behavioral analysis module configured to analyze the behavior of a suspected ransomware; and
c. a response component comprising:
i. a suspend/kill module configured to suspend the suspected ransomware;
ii. a restore files module configured to restore files from an on-demand backup system;
iii. a capture encryption key module configured to retrieve the encryption used by the suspected ransomware; and
iv. a quarantine module configured to quarantine the suspected ransomware on the device, and to quarantine the device off a network, to prevent spread of infection.

2. The system of claim 1, wherein the detection component operates within a kernel-level access.

3. The system of claim 1, wherein the response component operates within a kernel-level access.

4. The system of claim 1, wherein the detection component further comprises a machine-learning module.

5. The system of claim 1, wherein the decoy segments are on-demand and dynamic.

6. The system of claim 1, wherein the behavioral analysis module determines spread of the suspected ransomware and triggers the response component when a predetermined threshold of spread is passed.

7. An anti-ransomware method, comprising the steps of:
a. operating a deception component, wherein a decoy module of the deception component places and monitors decoy segments within one or more file structures.
b. operating a detection component wherein a machine learning module of the detection component determines a file system baseline for the computer file structure, and a behavioral analysis module analyzes a suspected ransomware;
c. operating a response component which responds to a suspected ransomware by an action selected from the group consisting of suspending the suspected ransomware process, restoring files from a backup, capturing an encryption key, and quarantining the suspected ransomware.

8. The method of claim 7, wherein the detection component further comprises the steps of:
d. engaging in preventative static analysis of the suspected ransomware prior to execution, wherein if the suspected ransomware is suspicious the detection component is moved to a suspicious state, and wherein if the suspected ransomware is malicious the detection component is moved to a malicious state and wherein if the suspected ransomware is safe, the detection component is moved into a safe state;
e. engaging in early dynamic analysis of the suspected ransomware wherein if the suspected ransomware is suspicious the detection component is moved to a suspicious state, and wherein if the suspected ransomware is malicious the detection component is moved to a malicious state and wherein if the suspected ransomware is safe, the detection component is moved into a safe state;
f. engaging in ongoing dynamic analysis of the suspected ransomware wherein if the suspected ransomware is suspicious the detection component is moved to a suspicious state, and wherein if the suspected ransomware is malicious the detection component is moved to a malicious state and wherein if the suspected ransomware is safe, the detection component is moved into a safe state;
g. wherein if the detection component ends in a safe state, a flag is not raised, and data is sent to a cloud computer through a secure tunnel;
h. wherein if the detection component ends in a suspicious state, a flag marked suspicious is raised, and data is sent to a cloud computer through a secure tunnel; and
i. wherein if the detection component ends in a malicious state, a flag marked malicious is raised, and data is sent to a cloud computer through a secure tunnel.

9. The method of claim 7, wherein the response component comprises the steps of:
d. receiving a flag marked suspicious or malicious from the detection component;
e. analyzing the suspected ransomware, whereas if ransomware is confirmed, suspending a ransomware process, restoring backed up files, undoing malicious modifications made by the ransomware, and quarantining the ransomware off-network.

10. The method of claim 9 further comprising the step of the user confirming that the process is malicious.

11. The method of claim 9 further comprising the step of an artificial intelligence system confirming that the process is malicious.

12. The method of claim 9 further comprising the step of a security analyst reviewing the data associated with the security event, and confirming that the process is malicious.

13. The method of claim 9 further comprising the step of an automated response confirming that the process malicious.

14. The method of claim 9 further comprising the step of deleting the ransomware file.

15. The method of claim 9 further comprising the step of backing up one or more files that are targets for encryption prior to the start of encryption.

16. The method of claim 15, wherein the backing up is performed on-demand.

17. The method of claim 9 further comprising the step of capturing the encryption key from memory and decrypting files that have been encrypted by the ransomware.

18. The method of claim 17 further comprising the step of sending the encryption key to a cloud computer through a secure tunnel.

19. The method of claim 7 wherein the decoy segments are placed within the folder of the suspected ransomware.
